(19) United States
(12) Patent Application Publication
(10) Pub. No.: US 2007/0118446 A1
(43) Pub. Date: May 24, 2007

(54) System and method for managing relationships in a procurement transaction

(76) Inventors: Tanja Soehngen, Altlussheim (DE); Frank Milpetz, Wiesloch (DE); Patrick Karcher, Gaggenau (DE); Paola Sala, Heidelberg (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/256,106

(22) Filed: Oct. 24, 2005

(51) Int. Cl. G07F 19/00

(52) U.S. Cl. 705/34

(57) ABSTRACT

Systems and methods are disclosed for managing a plurality of invoicing parties associated with a business partner in a procurement management system. The system may suggest an invoicing party as a default invoicing party in an invoice associated with the business partner. The suggested invoicing party may be selected from the plurality of invoicing parties associated with the business partner. The procurement management system may allow the user to replace the suggested default invoicing party in the invoice with another invoicing party from the plurality of invoicing parties associated with the business partner.

### DESCRIPTION OF THE INVENTION

1. Field of the Invention

The present invention relates generally to the management of business partners in a procurement management system. More specifically, the present invention relates to the management of a plurality of invoicing parties associated with a business partner in a procurement management system.

2. Background of the Invention

Business transactions are essentially exchanges between different business partners. A business partner may be an individual, a group of individuals, a company, or any other entity that is recognizable by other such entities as being capable of participating in exchanges. Typically, a business partner, who is frequently involved in a large number of transactions, may employee or otherwise engage one or more specialized or sub-level business partners to perform the various tasks associated with the transactions. As an example, a large company may have internally designated contact persons, shipping managers, invoicing parties, and a number of other internally designated business partners for handling various specialized transactional tasks. Sometimes, a business partner may also assign performance of some of its business functions to other external business partners. For example, shipping and invoicing functions of a business partner may be contracted or otherwise assigned to external companies or individuals who specialize in providing such services. Under certain circumstances, business partner tasks such as invoicing tasks, may be assigned to a creditor of the business partner. In this way, the business partner may allow the creditor to directly receive funds from the business partner's transaction.

Many of today's business transactions are carried out using specialized software and systems. For example, a procurement management system may be provided to facilitate procurement-related transactions, including purchase order placements, invoice issuances, and a variety of other suitable transactions. The procurement management system may allow user interactions through a variety of user interfaces. At least one business partner may be referenced in each of these interfaces. As an example, in a purchase order entry interface, the procurement management system may verify and save one or more vendors, one or more purchasers, and any other business partners involved in the purchase. As another example, when displaying an invoice to the user, the procurement management system may identify which vendor the product came from, the sales agent that had carried out the sale, any invoicing party that is to be paid, and any other suitable business partner. Thus, in order to properly carry out and document the transactions, the procurement management system relies heavily on its capability to accurately identify the business partners involved.

While accurate identification of business partners is important in a procurement management system, current identification procedures in these systems remain associated with a very simplistic categorization scheme. For example, in such a system, business partners may be simply identified as vendors, invoice recipients, and a few other rather general categories of business partners. This simplistic categorization operates based on a number of assumptions, including, for example, the assumption that a vendor is responsible for providing a whole range of functions including provision of goods and services, shipping the goods and/or delivering the services, invoicing the transactions, and performing any other seller-oriented functions. This blanket assumption ignores the fact that, in actuality, very few vendors handle every one of the above functions without further delegation to other sub-level or external business partners. Thus, in the above system, the vendor bears the burden of manually filtering and forwarding the appropriate information, which the procurement management system has generally categorized as vendor information, to the appropriate designated sub-level or external business partners.

Accordingly, it is desirable to provide a method and system that enables the creation and management of related business partners so that appropriate information and tasks in a procurement management system may be directed to the appropriate business partners who will use the information and/or perform the tasks. More specifically, it is desirable to provide a method and system that enables the creation and management of a business partner having multiple associated invoicing parties, so that appropriate information and tasks may be assigned and forwarded to the appropriate invoicing party.

### SUMMARY OF THE INVENTION

Consistent with the principles of the present invention, a system and method is disclosed for managing a plurality of invoicing parties associated with a business partner in a procurement management system.

Consistent with the principles of the present invention, the procurement management system may provide a series of interfaces in which the user may input, edit, and manage business partner-related information, including a business partner's relationships with one or more associated invoicing parties. The system may suggest an invoicing party as a default invoicing party in an invoice associated with the business partner. The suggested invoicing party may be selected from the plurality of invoicing parties associated with the business partner. The procurement management system may allow the user to replace the suggested default invoicing party in the invoice with another invoicing party from the plurality of invoicing parties associated with the business partner.

Consistent with the principles of the present invention, the procurement management system may suggest a vendor for an invoice based on an invoicing party associated with the invoice. The procurement management system may make such a suggestion by first determining for which business partners the invoicing party associated with the invoice serves as default invoicing party. Based on this determination, the procurement management system may suggest one of the determined business partners as the vendor in the present invoice. The procurement management system may select one of the determined business partners based on a variety of criteria including, for example, a priority of the business partners associated with the invoicing party or any other suitable criteria.

It is to be understood that both the foregoing general description and the following detailed description are exemplary and explanatory only and are not restrictive of the invention as claimed. The foregoing background and summary are not intended to provide any independent limitations on the claimed invention.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is an illustrative interface for managing business partners consistent with the principles of the present invention.

FIG. 2 is an illustrative interface for managing invoicing party relationships consistent with the principles of the present invention.

FIG. 3 is an illustrative interface for invoice entry consistent with the principles of the present invention.

FIG. 4 is a flowchart of illustrative steps involved in providing an invoicing party from a plurality of invoicing parties associated with a vendor consistent with the principles of the present invention.

FIG. 5 is a flowchart of illustrative steps involved in suggesting a vendor for an invoice based on a default invoicing party associated with the vendor consistent with the principles of the present invention.

FIG. 6 is an illustrative computer system for implementing a software application consistent with the principles of the present invention.

FIG. 7 is another illustrative computer system for implementing a software application consistent with the principles of the present invention.

### DETAILED DESCRIPTION

The following detailed description refers to the accompanying drawings. Wherever possible, the same reference numbers are used in the drawings and the following description to refer to the same or similar parts. While several exemplary versions and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding steps to the disclosed methods. Accordingly, the following detailed description does not limit the invention. Instead, the proper scope of the invention is defined by the appended claims.

As mentioned above, business partner-related data is critical to various functions of a procurement management system. Due to its importance, definition and modification of such data may be restricted to authorized users. An authorized user may be, for example, an individual who is designated to perform business partner management-related activities by the proprietor of the procurement management system or designated as an authorized user through any other suitable means. Consistent with the principles of the present invention, the scope of the business partner management activities that an authorized user may perform may be restricted, for example, based on the user's role or other suitable user characteristics. In one example, an external vendor, who is designated as an authorized user, may have limited authority to modify its own associated group of invoicing parties. Consistent with the principles of the present invention, the authorized user may perform business partner management-related activities in various user interfaces.

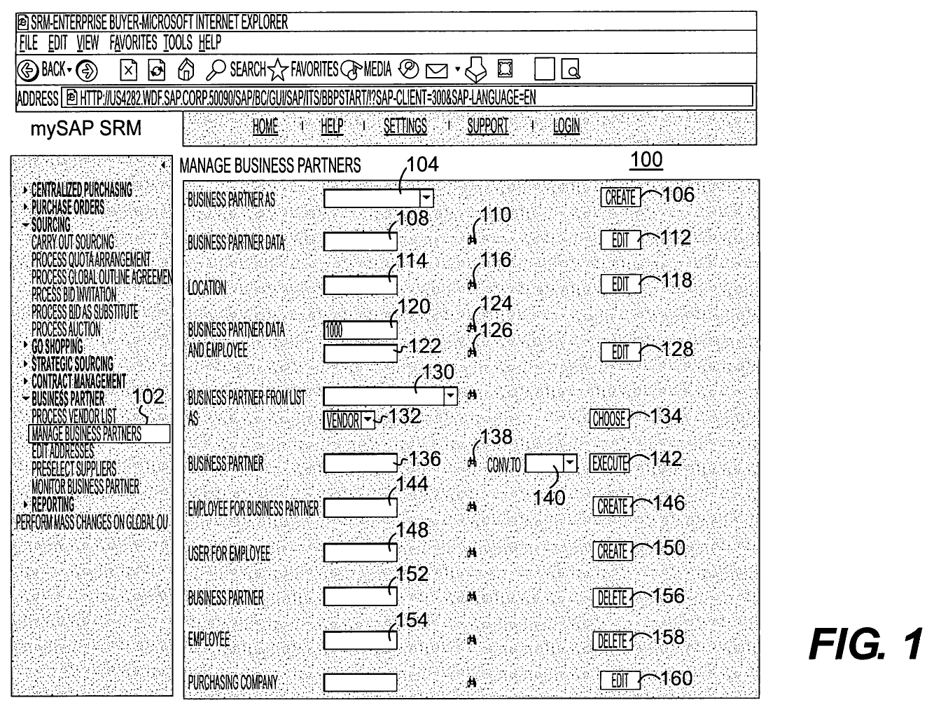

FIG. 1 shows an illustrative interface 100 for allowing an authorized user to manage business partners in a procurement management system consistent with the principles of the present invention. Interface 100 may be displayed to the user, for example, in response to a determination that an authorized user has requested to perform business partner management-related activities, for example, by selecting manage business partners option 102.

Consistent with the principles of the present invention, the authorized user may create a new business partner using interface 100. To create the new business partner, the user may first specify a type or category to which the new business partner will belong. The assignment of a type or category allows the new business partner to be referenced and assigned to tasks in its appropriate capacity based on its associated type or category. The types or categories of business partners that the user may choose to assign to the new business partner may be pre-defined and divided into external business partner types and internal business partner types. The external business partner types may include bidder, vendor, invoicing party, contact person, ship-from address, and any other suitable external business partner type. A bidder may be, for example, any company that is able to submit bids in response to a bid invitation. A vendor may be any business partner from whom goods and services may be obtained. An invoicing party may be an individual or suitable entity designated by a vendor to send out invoices and, in many cases, receive payments. A contact person may be a specific individual designated by a bidder or vendor to represent the bidder or vendor in a limited capacity. Ship-from address may be the primary outbound delivery address from which the goods are shipped.

Internal business partner types, on the other hand, may include requester, purchasing company, goods recipient, ship-to address, location, invoice recipient, and any other suitable internal business partner type. A requester may be, for example, a business partner who requests a particular procurement-related activity such as an invoice entry. A purchasing company may be a company that uses the procurement management system for purchasing-related tasks. A goods recipient may be an employee in a company that confirms goods receipt or performance of service. A ship-to address may be a delivery address for goods purchased. A location may be an address such as a processing plant location. An invoice recipient may be a business partner to whom the invoice is sent. The list of both internal and external business partner types may be supplemented or otherwise modified without departing from the spirit of the present invention.

Consistent with the principles of the present invention, the user may select an internal or external business partner type, for example, from drop down menu 104. Consistent with the prin, the list of business partner types that may be selected from drop down menu 104 may be restricted to a subset of the entire list of pre-defined business partner types, for example, based on user authorization, or any other suitable consideration.

The user may create a new business partner of the selected business partner type using, for example, create button 106. Once a business partner is created, the user may select the business partner for viewing and editing. For example, the user may input a business partner of types including, for example, bidder, vendor, invoicing party, or any other suitable type, for editing in field 108. The user may search for such a business partner for editing using search button 110. When the desirable business partner is found, the user may invoke editing of data associated with the business partner using, for example, edit button 112. Edits of any suitable type may be performed separately from edits of other business partner types. As an example, in interface 100, searching and editing of the type location may be invoked separately, for example, using field 114 and buttons 116 and 118.

Sometimes, it may be desirable for the user to edit data associated with a business partner concurrently with data associated with the business partner's various employees. In the present example, interface 100 provides simultaneous editing of both business partner and its associated employees through related fields 120, 122 and buttons 124-128.

Consistent with the principles of the present invention, the user, when creating a business partner of a particular type, may choose the data associated with the business partner from a stored source. In the present example, user selection of business partner data may be performed in connection with a drop down menu 130. The user may assign a particular business partner type to the selected business partner data using another drop down menu 132. The selections made in drop down menus 130 and 132 may be used to create a new business partner using button 134. Consistent with the principles of the present invention, the business partner data of drop down menu 130 may be chosen by the procurement management system based on a variety of criteria, including, for example, the identity of the authorized user.

Consistent with the principles of the present invention, data associated with an existing business partner may be copied and converted into a new business partner of another type. As an example, the user may input or search for an existing business partner for conversion using field 136 and button 138. Once the existing business partner is identified, the user may select the new business partner type into which the existing business partner is to be converted, for example, from drop down menu 140. The conversion may be executed using button 142.

Consistent with the principles of the present invention, a business partner may have one or more associated employees. In interface 100, the user may input and create an employee for a business partner using field 144 and button 146. Consistent with the principles of the present invention, an employee may also have an associated user. As an example, an employee may be associated with a user who has certain authorizations that may, for example, enable the user/employee to manage business partner-related information. In interface 100, a user may be created for an employee using field 148 and button 150.

Consistent with the principles of the present invention, one or more business partners may be closely related, so that the existence of one is dependent upon the existence of the other. As an example, a contact person may be a dependent of a vendor or bidder and cannot exist as an independent business partner if the vendor or bidder upon whom it depends does not exist. Accordingly, when creating a dependent business partner, it may be required that the business partner upon whom the dependent business partner depends be specified. Consistent with the principles of the present invention, certain business partners may be required to have associated dependent business partners. As an example, a vendor may be required to have an associated contact person. In such a situation, when the primary business partner is created, the system may require the creation of a necessary dependent business partner.

Consistent with the principles of the present invention, the procurement management system may allow the deletion of business partners and employees of business partners. Prior to a deletion, the procurement management system may check and verify that the business partner and/or employee is not associated with any open transactions or any other pending or open activities. Consistent with the principles of the present invention, a deletion of a business partner may include the deletion of one or more associated business partners, employees, users, or any other suitable entities that depend upon the business partner. Thus, the procurement management system may additionally verify that these dependent business partners and other suitable entities are not associated with open transactions or activities prior to deletion. In interface 100, the user may request deletion of a business partner or employee of a business partner using fields 152 and 154 and delete buttons 156 and 158. Interface 100 may additionally provide editing of business partners of type purchasing company using, for example, button 160.

It will be understood that interface 100 is merely illustrative of such an interface for managing business partners in a procurement management system. Elements may be added or omitted from interface 100 without departing from the spirit of the present invention.

As mentioned above, a business partner, such as a vendor, may have one or more associated business partners of type invoicing party. An invoicing party may also serve the invoicing needs of one or more business partners. In order to accommodate these possible multilateral relationships, when a business partner of type invoicing party is created in the procurement management system, for example, using an interface such as interface 100 of FIG. 1, the procurement management system may require the specification of one or more relationships between the invoicing party and any business partners for whom the invoicing party serves. Similarly, when creating a business partner that requires the functionalities of an invoicing party in the procurement management system, as in the case of a vendor, the system may require the specification or selection of one or more invoicing parties.

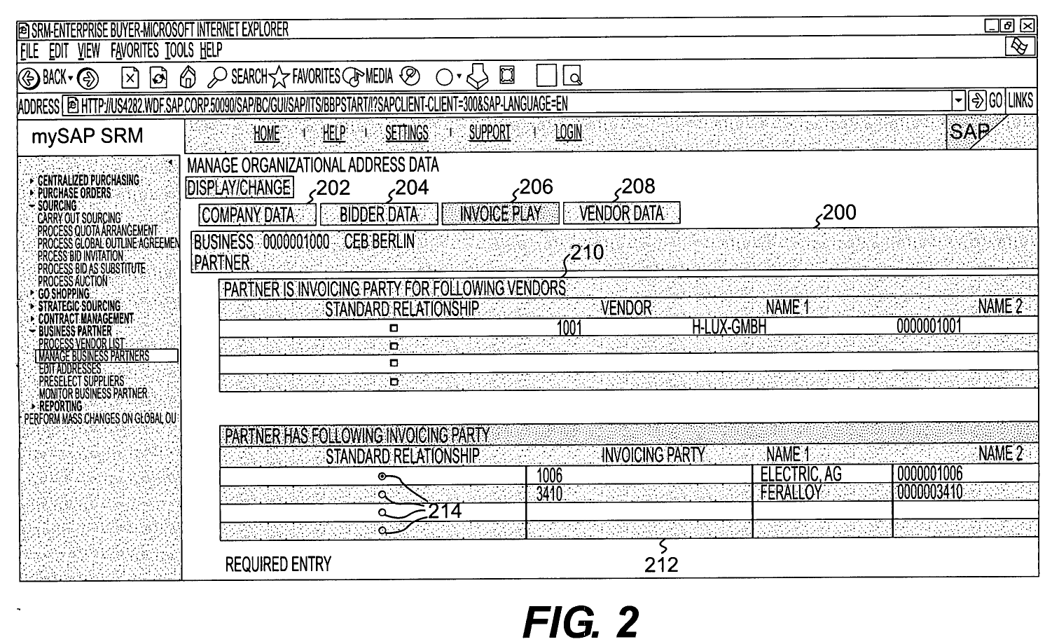

Management of various multilateral relationships between invoicing parties and the business partners that the invoicing parties serve may be provided through one or more interfaces in the procurement management system. As an example, an interface, such as interface 200 of FIG. 2, may be provided to enable an authorized user to manage invoicing party relationships. The user may access interface 200 by, for example, searching the system for an existing business partner of type invoicing party and requesting to edit data associated with the invoicing party. The user may issue such a search and edit request, for example, using field 108 and edit button 112 of FIG. 1.

In response to such a request, the procurement management system may provide the authorized user with options to edit information, including invoicing party relationships, associated with a business partner. For example, tabs 202-208 may be provided to enable the user to access the various types of information associated with the business partner. It will be understood that tabs 202-208 may be added, removed, made inactive, or otherwise modified without departing from the spirit of the present invention.

In the present example, the user may use tab invoice flag 206 to access the invoicing party relationships associated with the current business partner. Consistent with the principles of the present invention, two types of invoicing party relationships may be included in an interface such as interface 200. The two types of invoicing party relationships may include relationships in which the current business partner serves as the invoicing party for other business partners, such as vendors, and relationships in which the current business partner has one or more designated invoicing parties.

In the present example, relationships in which the current business partner serves as invoicing party for other business partners are shown in table 210. In table 210, some attributes of each business partner, including various names or other references for referring to the business partner, may be shown. The one or more business partners listed in table 210 may be automatically selected by the system based on, for example, the identity of the current business partner or any other suitable criteria. Alternatively, the listed business partners may be selected by the user or selected by any other suitable means. It will be understood that any suitable business partners may be selected for the above list without departing from the spirit of the present invention.

Consistent with the principles of the present invention, the current business partner may simultaneously serve as invoicing party for any number of associated business partners listed in table 210. Accordingly, a selection mechanism such as a set of checkboxes, which allows the user to select more than one business partners to whom to serve as invoicing party, may be provided in table 210.

Consistent with the principles of the present invention, the current business partner may also be associated with one or more designated invoicing parties. As an example, a business partner that is an international vendor may have different invoicing parties in two or more of its regions or countries of operation. As another example, a vendor, who has an in-house invoicing party, may designate one of its creditors as the invoicing party in some of its transactions so that the creditor may be directly paid by the buyers. Through these examples, it is easy to see the advantages of allowing a business partner to have more than one associated invoicing party. However, when more than one invoicing party is associated with a single business party, confusion may arise as to which invoicing party is responsible for a particular transaction. To address such confusion, the procurement management system may require the designation of one of the business partner's associated invoicing parties as the responsible invoicing party in each of the business partner's transactions.

While the above requirement resolves the confusion as to which invoicing party is responsible for a transaction, it may be too tedious and repetitious for the business partner to perform on a regular basis. Accordingly, the procurement management system may additionally allow the designation of a default invoicing party for a business partner. The default invoicing party may be, for example, the most often used invoicing party among the plurality of invoicing parties associated with the business partner or a default invoicing party selected based on any other suitable criteria. When preparing an invoice, the procurement management system may suggest the default invoicing party as the responsible invoicing party for that invoice. If desired, the business partner may be allowed to replace the suggested default invoicing party with another invoicing party from its plurality of invoicing parties.

In the present example of FIG. 2, the plurality of invoicing parties associated with the current business partner may be displayed in table 212. Each invoicing party listed in table 212 may include some attributes associated with the invoicing party, including invoicing party name, reference number, or any other suitable information. Because only one invoicing party may be selected as the default invoicing party, a mechanism for making a single selection, such as a set of radio buttons 214, may be provided in table 212.

It will be understood that interface 200 is merely illustrative of such an interface for facilitating the management of invoicing party relationships. Any other suitable screens or interfaces may be used without departing from the spirit of the present invention.

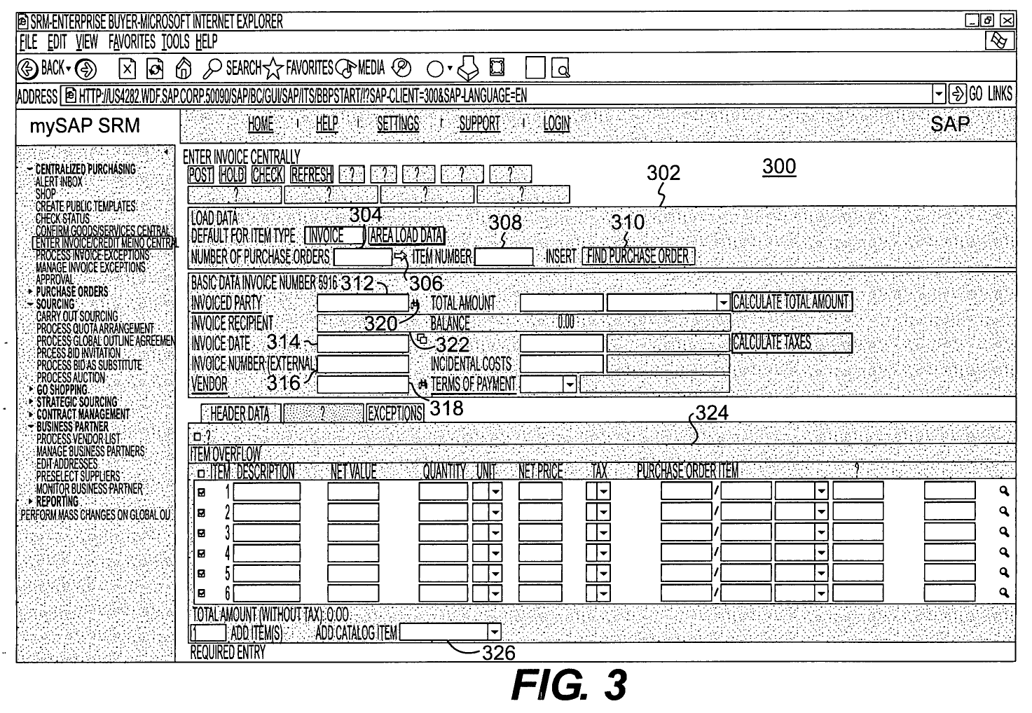

FIG. 3 is an exemplary invoice entry screen 300 in which a default invoicing party may be suggested consistent with the principles of the present invention. The invoice input entry screen 300 may be provided to allow a user to enter a new invoice, for example, in response to receiving an invoice or in response to any other appropriate event.

A load data section 302 may be provided on screen 300. In this section, the user may insert items into the invoice, for example, by loading data associated with the items from one or more related documents in the system. In this particular example, the user is allowed to load item data from a number of existing purchase orders. For example, the user may provide a known purchase order number of a related purchase order in field 304. The user may obtain this number, for example, from a received invoice, which references the purchase order.

In accordance with a system consistent with the principles of the present invention, the user may press button 306 to display a new screen or interface in which the user may enter or select multiple purchase orders, for example, using a mechanism for multiple selection. In the event that the user does not know the specific purchase order number of one or more related purchase orders, the user may request a general search for the one or more purchase orders using, for example, the find purchase order option 310. In this option, the user may use various criteria, such as a vendor, an invoicing party, or any other suitable criteria, to search for a related purchase order. While data loading from related documents such a purchase order is specifically described above, it is not the only way to input item data into an invoice. The user may manually input various invoice and item data or use any other suitable input means for entering such data without departing from the spirit of the present invention.

In addition to loading invoice data from preexisting documents, data may also be inputted into various fields of the invoice entry. Consistent with the principles of the present invention, the procurement management system may automatically suggest an invoicing party in invoicing party field 312. As an example, the procurement management system may suggest an invoicing party that has been previously selected as a default invoicing party, for example, from the plurality of invoicing parties associated with the vendor involved in the current invoice, as shown in interface 200 of FIG. 2. The user may replace the suggested default invoicing party or otherwise input data for invoicing party 312, for example, by invoking a search function using search icon 320. In response to the user invoking the search option, the system may search for, for example, the plurality of invoicing parties associated with the business partner, a list of invoicing parties associated with the current user, a list or database associated with any related documents such as a purchase order, or any other suitable list or database. The user may select a desired invoicing party from the result of the search. Other data such as invoice date 314, external invoice number 316, vendor 318, and a number of other suitable types of information may also be inputted.

When inputting invoicing data in screen 300, certain types of information may be prevented from user modification, for example, to prevent human errors or unauthorized data manipulation. Prevention of user modification may be achieved by, for example, making the data field inactive or by using any other suitable method. In the present example, the field invoice recipient 322 is made inactive. This may prevent a user, who may be the invoice recipient, from making modification to this field. An inactive field or other such restricted information may be made available for modification, for example, when the user is identified as an authorized user for making such modifications.

In portion 324 of screen 300, an overview of the various line items included in the invoice may be displayed. Some attributes or specifics to each of the line item, such as, for example, a description, a net value, quantity, net price, tax, etc. may be displayed. The user may add or modify items manually using the provided input means (e.g., text boxes and drop down menus). Alternatively, the user may choose to add an item and its associated data from a stored catalog by, for example, selecting the item from catalog 326.

It will be understood that invoice entry interface 300 is merely illustrative of such an interface. Any other suitable screens or interfaces may be used without departing from the spirit of the present invention.

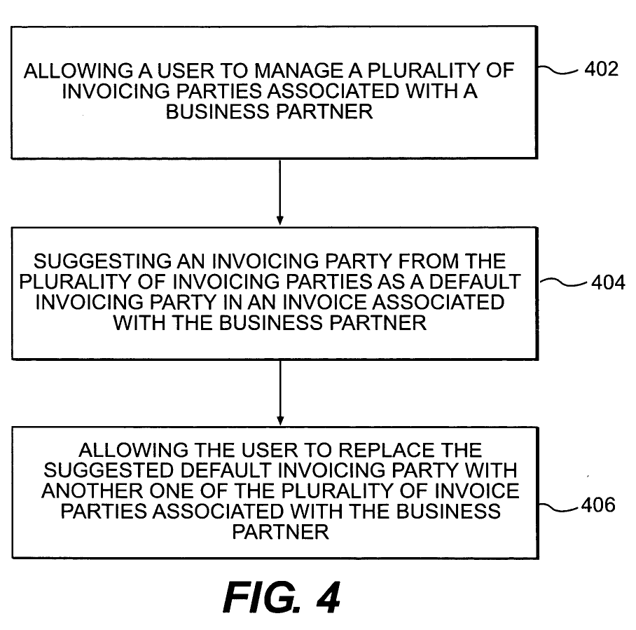

FIG. 4 shows a flowchart of illustrative steps involved in suggesting a default invoicing party from a plurality of invoicing parties associated with a business partner in a procurement management system consistent with the principles of the present invention. At step 402, the procurement management system may allow a user to manage a plurality of invoicing parties associated with a business partner. For example, the procurement management system may provide a series of interfaces, such as interface 100 of FIG. 1 and interface 200 of FIG. 2 in which the user may input, edit, and manage business partner-related information, including a business partner's relationships with one or more associated invoicing parties.

At step 404, the system may suggest an invoicing party from the plurality of invoicing parties associated with the business partner as a default invoicing party in an invoice associated with the business partner. As an example, the business partner may be a recognized vendor of an invoice, for example, an invoice as shown in interface 300 of FIG. 3. The procurement management system may suggest an invoicing party for the invoice, for example, based on a previous selection of a default invoicing party in connection with the business partner, as shown in table 212 of FIG. 2. Any other suitable means or methods may be used to select a default invoicing party from the plurality of invoicing parties associated with the business partner without departing from the present invention. The suggested invoicing party may be shown, for example, in invoicing party field 312 of FIG. 3.

At step 406, the procurement management system may allow the user to replace the suggested default invoicing party in the invoice with another invoicing party from the plurality of invoicing parties associated with the business partner. The user may make such a replacement, for example, using the invoicing partner search button 320 of FIG. 3. Any other suitable method or mechanism of replacing the suggested default invoicing party with another invoicing partner from the plurality of invoicing parties associated with the business partner may be used without departing from the spirit of the present invention.

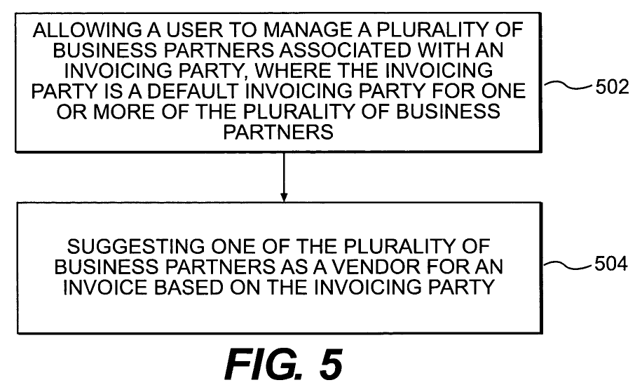

FIG. 5 shows illustrative steps involved in suggesting a vendor for an invoice based on an invoicing party consistent with the principles of the present invention. At step 502, the procurement management system may allow a user to manage a plurality of business partners associated with an invoicing party. As an example, the procurement management system may provide a series of interfaces, such as interface 100 of FIG. 1 and interface 200 of FIG. 2, to allow the user to manage business partner data, which may include the management of business partners associated with an invoicing party, for example, as shown in table 210 of FIG. 2, and the management of invoicing parties associated with a business party, for example, as shown in table 212 of FIG. 2.

At step 504, the procurement management system may suggest a vendor for an invoice based on an invoicing party associated with the invoice. As mentioned above, a vendor may be a business partner to whom a plurality of invoicing parties is associated. Also as mentioned above, each business partner, including a vendor, may have a designated default invoicing party. When an invoicing party associated with an invoice is known, for example, from an existing purchase order related to the invoice, from a goods receipt related to the invoice, from user input, or from any other suitable source, the procurement management system may determine for which business partners the invoicing party serves as the default invoicing party. Based on this determination, the procurement management system may suggest one of the determined business partners as the vendor in the present invoice. The procurement management system may select one of the determined business partners based on a variety of criteria including, for example, a priority of the business partners associated the invoicing party or any other suitable criteria.

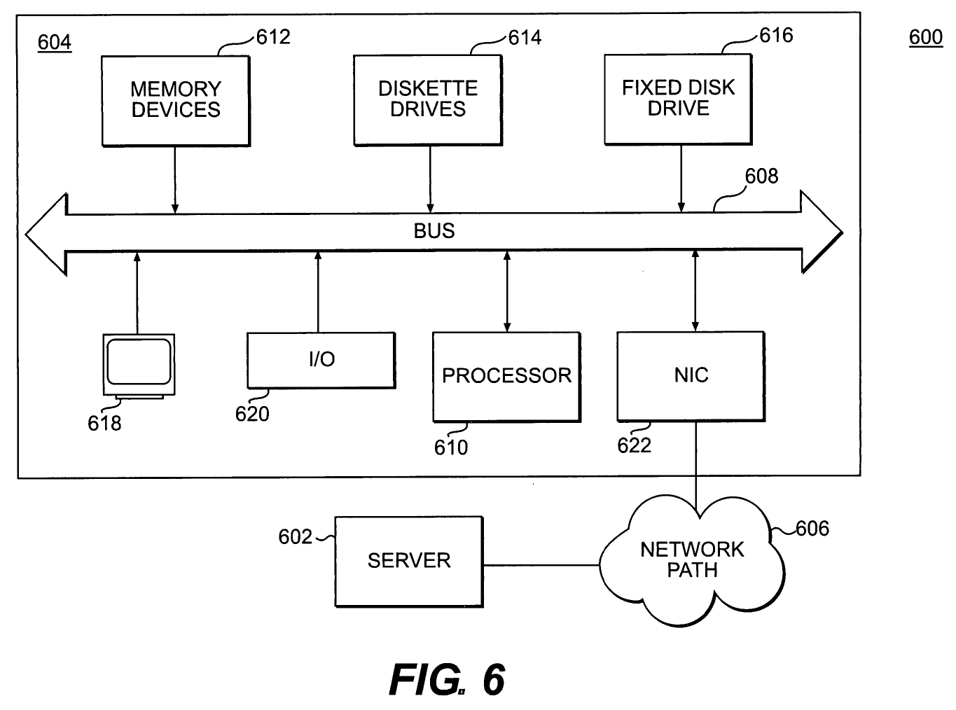

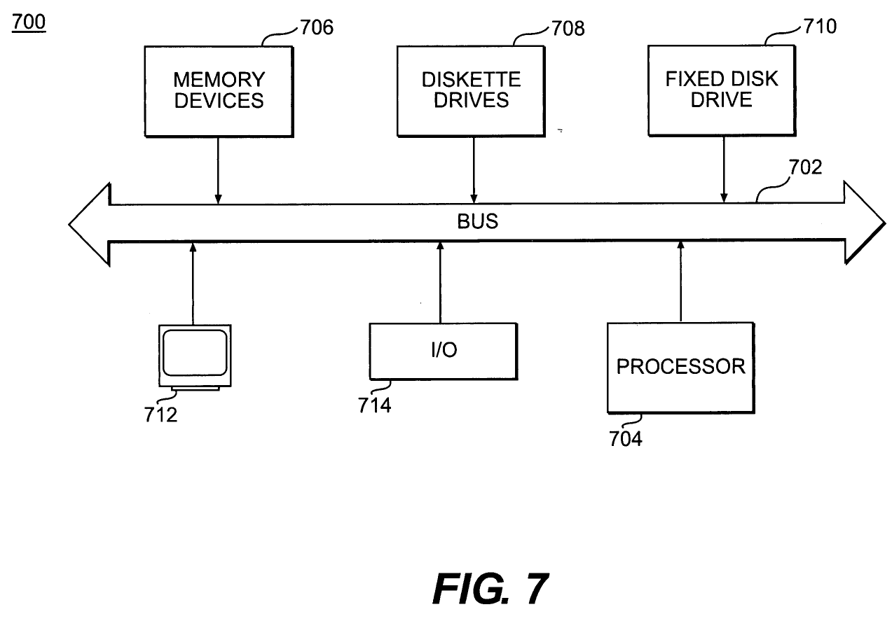

A computer system may be used to install a software application implementing a system consistent with the principles of the present invention. The computer system may be a computer network, as shown in FIG. 6, or a stand-alone personal computer (PC), as shown in FIG. 7.

As shown in FIG. 6, a computer network 600 consistent with the principles of the present invention may include a server 602 and a stand-alone PC 604 connected through a network path 606. Computer network 600 may be a local area network (LAN), where server 602 and PC 604 are workstations. Computer network 600 may also be the Internet, with server 602 hosting a web application and PC 604 being any workstation available to a user desiring to interface with the application on server 602. Alternatively, computer network 600 may be a wide area network (WAN), and server 602 and PC 604 may lie in two separate LANs connected through the Internet.

PC 604 may include a bus line 608 connecting a plurality of devices such as a processor 610, memory devices 612 for storage of information, diskette drives 614, a fixed disk drive 616, a monitor or display 618, other I/O devices 620, and a network interface card (NIC) 622. Processor 610 may be a microprocessor such as an Intel Pentium™ chip for processing applications. Memory devices 612 may include read-only memories (ROM) and/or random access memories (RAM). Diskette drives 614 may include a floppy drive and/or a compact disk (CD) drive. Fixed disk drive 616 may be a hard drive. I/O devices 620 may include a keyboard and/or a mouse for receiving input from a user of PC 604. Monitor or display 618 may display output from processor 610, and may also echo the input of the user. PC 604 may be connected to network path 606 through NIC 622.

A web application may be installed on server 602. An individual desiring to enter data into the application on server 602 may use a web browser loaded on PC 604, and may communicate with server 602 through NIC 622 and network path 606. In one aspect, software application for implementing a system consistent with the principles of the present invention may be stored in PC 604 and processor 610 of PC 604 may execute the software application locally within PC 604 and interface with a web application on server 602. Particularly, the software application may be stored on a floppy disk, a CD, or any other suitable readable media, which may be accessible by diskette drive 614, fixed disk drive 616, or any other suitable mechanism. In another aspect, the software application for implementing a system consistent with the principles of the present invention may be stored in server 602, which may execute the software application, and processor 610 of PC 604 may communicate with server 602 to send information to server 602 and retrieve the results of the execution of the software application from server 602.

Through the execution of the software application implementing a system consistent with the principles of the present invention, either locally within PC 604 or remotely within server 602, an interface may be provided on a user display, which enables the user to input, view, and interact with an invoice having one or more line items of different line item types.

Alternatively, as shown in FIG. 7, a stand-alone PC 700 may be used for implementing a software application implementing a system consistent with the present invention. PC 700 may include a bus line 702 connecting a plurality of devices, which may include a processor 704, memory devices 706 for storage of information, diskette drives 708, a fixed disk drive 710, a monitor or display 712, and other I/O devices 714. Processor 704 may be a microprocessor such as an Intel Pentium™ chip for processing applications. Memory devices 706 may include ROM and/or RAM. Diskette drives 708 may include a floppy drive and/or a compact disk (CD) drive. Fixed disk drive 710 may be a hard drive. Monitor or display 712 may display the output of processor 704 and may also echo the input of the user. I/O devices 714 may include a keyboard and/or a mouse for receiving input from a user of PC 700.

A software application implementing a system consistent with the principles of the present invention may be stored on a floppy disk or a CD accessible by diskette drive 708 or on fixed disk drive 710. Processor 704 may execute the software application stored in the floppy disk the CD or the fixed disk drive 710. An individual, through monitor or display 712 and I/O devices 714, may interact with processor 704, which may execute the software application. A software application implementing a system consistent with the principles of the present invention may be written in any number of programming languages, including but not limited to JavaScript, Visual Basic, Flash, ABAP coding, or any other suitable language. Similarly, the present invention is not limited to use with certain applications, Internet browsers or operating systems.

Furthermore, the invention may be practiced in an electrical circuit comprising discrete electronic elements, packaged or integrated electronic chips containing logic gates, a circuit utilizing a microprocessor, or on a single chip containing electronic elements or microprocessors. The invention may also be practiced using other technologies capable of performing logical operations such as, for example, AND, OR, and NOT, including but not limited to mechanical, optical, fluidic, and quantum technologies. In addition, the invention may be practiced within a general purpose computer or in any other circuits or systems.

While the present invention has been described in connection with various embodiments, many modifications will be readily apparent to those skilled in the art. One skilled in the art will also appreciate that all or part of the systems and methods consistent with the present invention may be stored on or read from computer-readable media, such as secondary storage devices, like hard disks, floppy disks, and CD-ROM; a carrier wave received from a network such as the Internet; or other forms of ROM or RAM. Accordingly, embodiments of the invention are not limited to the above described embodiments and examples, but instead is defined by the appended claims in light of their full scope of equivalents.

What is claimed is:

1. A method for managing business partners in a procurement management system, the method comprising:
allowing a user to manage a plurality of invoicing parties associated with a business partner in a first interface;
suggesting an invoicing party from the plurality of invoicing parties as a default invoicing party in an invoice associated with the business partner in a second interface; and
allowing the user to replace the suggested default invoicing party in the second interface with another one of the plurality of invoices parties associated with the business partner.

2. The method of claim 1, wherein allowing the user to manage the plurality of invoicing parties comprises allowing the user to select one of the plurality of invoicing parties as a user-selected default invoicing party in the first interface.

3. The method of claim 1, wherein allowing the user to manage the plurality of invoicing parties comprises allowing the user to change the default invoicing party in the first interface.

4. The method of claim 2, wherein suggesting an invoicing party from the plurality of invoicing parties as the default invoicing party comprises suggesting the user-selected default invoicing party as the default invoicing party in the second interface.

5. A method for managing business partners in a procurement management system, the method comprising:
allowing a user to manage a plurality of business partners associated with an invoicing party in a first interface, wherein the invoicing party is a default invoicing party for a first of the plurality of business partners; and
suggesting the one of the plurality of business partners as a vendor for an invoice in a second interface based on the invoicing party.

6. The method of claim 5, wherein the invoicing party is also a default invoicing party for a second of the plurality of business partners.

7. The method of claim 6, further comprising suggesting one of the first or second of the plurality of business partners as the vendor for the invoice in the second interface.

8. A system for managing business partners, the system comprising:
an I/O device;
a display; and
a processor configured to:
provide a first interface on the display that allows a user to manage a plurality of invoicing parties associated with a business partner using the I/O device;
provide a suggestion of an invoicing party from the plurality of invoicing parties as a default invoicing party in an invoice associated with the business partner in a second interface on the display; and
allow the user to replace the suggested default invoicing party in the second interface with another one of the plurality of invoices parties associated with the business partner.

9. The system of claim 8, wherein the processor is further configured to allow the user to select one of the plurality of invoicing parties as a user-selected default invoicing party in the first interface.

10. The system of claim 8, wherein the processor is further configured to allow the user to change the default invoicing party in the first interface.

11. The system of claim 10, wherein the processor is further configured to suggest the user-selected default invoicing party as the default invoicing party in the second interface.

12. A system for managing business partners, the system comprising:
an I/O device;
a display; and
a processor configured to:
provide a first interface on the display that allows a user to manage a plurality of business partners associated with an invoicing party using the I/O device, wherein the invoicing party is a default invoicing party for a first of the plurality of business partners; and
suggest the one of the plurality of business partners as a vendor for an invoice in a second interface on the display based on the invoicing party.

13. The system of claim 12, wherein the invoicing party is also a default invoicing party for a second of the plurality of business partners.

14. The system of claim 13, wherein the processor is further configured to suggest one of the first or second of the plurality of business partners as the vendor for the invoice in the second interface.

15. A computer-readable medium including instructions for performing, when executed by a processor, a method for managing business partners in a procurement management system, the method comprising:
allowing a user to manage a plurality of invoicing parties associated with a business partner in a first interface;
suggesting an invoicing party from the plurality of invoicing parties as a default invoicing party in an invoice associated with the business partner in a second interface; and
allowing the user to replace the suggested default invoicing party in the second interface with another one of the plurality of invoices parties associated with the business partner.

16. The computer-readable medium of claim 15 further includes instructions for allowing the user to select one of the plurality of invoicing parties as a user-selected default invoicing party in the first interface.

17. The computer-readable medium of claim 15 further includes instructions for allowing the user to change the default invoicing party in the first interface.

18. The computer-readable medium of claim 17 further includes instructions for suggesting the user-selected default invoicing party as the default invoicing party in the second interface.

19. A computer-readable medium including instructions for performing, when executed by a processor, a method for managing business partners in a procurement management system, the method comprising:
allowing a user to manage a plurality of business partners associated with an invoicing party in a first interface, wherein the invoicing party is a default invoicing party for a first of the plurality of business partners; and
suggesting the one of the plurality of business partners as a vendor for an invoice in a second interface based on the invoicing party.

20. The computer-readable medium of claim 19, wherein the invoicing party is also a default invoicing party for a second of the plurality of business partners.

21. The computer-readable medium of claim 20 further includes instructions for suggesting one of the first or second of the plurality of business partners as the vendor for the invoice in the second interface.
